(19) United States
(12) Patent Application Publication
(10) Pub. No.: US 2007/0214465 A1
(43) Pub. Date: Sep. 13, 2007

(54) OPTICAL DISC RECORDING AND/OR REPRODUCING DEVICE

(75) Inventors: Karel Gerardus Maria Koken, Eindhoven (NL); Myriam Sabine Josee Spets, Heppen (NL); Petrus Theodorus Jutte, Eindhoven (NL); Robertus Josephus Maria Verhoeven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,546

(22) PCT Filed: Apr. 28, 2005
(86) PCT No.: PCT/IB05/51398

§ 371 Date: Nov. 1, 2006

(30) Foreign Application Priority Data
May 6, 2004 (EP) 04101946.4

(51) Int. Cl. G11B 7/00

(52) U.S. Cl. 720/674

(57) ABSTRACT

An optical disc recording and/or reproducing device comprising an optical pickup unit (5) and guiding means (3,4,6,7,8) for displacing the optical pickup unit (5) in substantial radial direction and parallel to the surface of the rotating optical disc. Means are present for changing the tilting angle of the optical pickup unit (5) in a plane perpendicular to the said radial direction depending on the kind of optical disc (CD, DVD, BD) present in the device.

The invention is related to an optical disc recording and/or reproducing device comprising an optical pickup unit and guiding means for displacing the optical pickup unit in substantial radial direction with respect to the rotation axis of the optical disc in the device and parallel to the surface of the rotating optical disc.

Such device is for example disclosed in U.S. Pat. No. B-6,483,798. The device according to that publication comprises a driving system (using a spindle motor) for rotatably driving the optical disc, which driving system is mounted in a frame. The optical pickup unit is attached to the frame by means of two guiding rods, so that the optical pickup unit can be displaced in a straight path parallel to the surface of the rotating optical disc, in radial direction.

The optical pickup unit comprises an objective lens in order to direct laser radiation, emitted from a laser diode, in a converging beam on to the rotating optical disc so as to record information on the optical disc. When information is reproduced, a light beam is reflected by the optical disc and passes through the objective lens to arrive at a photo-detector provided within the optical pickup unit. Thereby, previously recorded information can be reproduced.

In the optical disc recording and/or reproducing device a correct position of the optical pickup unit relative to the surface of the optical disc is important in order to achieve an optimal and most reliable functioning of the device. Therefore, the parallel guidance for guiding the optical pickup unit along the surface of the rotating optical disc must be stable, so that the position of the objective lens of the pickup unit with respect to the surface of the rotating disc remains unchanged during the displacement of the optical pickup unit. Furthermore, as described in U.S. Pat. No. B-6,483,798, a fine tuning of the position of the optical pickup unit relative to the rotating optical disc can be performed after the device is assembled, to make sure that the best performance of the device is achieved.

By making use of the present device, information can be recorded or reproduced by means of different kinds of optical discs, such as a CD (Compact Disc), or a DVD (Digital Versatile Disc), or a BD (Blu-ray Disc). Although all these recording/reproducing systems make use of different techniques, they all can be applied in the same recording and/or reproducing device as described above, provided that the optical pickup unit comprises the required components for each of these techniques.

An object of the invention is an optical disc recording and/or reproducing device, whereby an adaptation of the laser beam depending on the kind of optical disc is achieved in an effective and relatively simple manner.

To accomplish with this object, means are present for changing the tilting angle of the optical pickup unit in a plane perpendicular to the said radial direction, depending on the kind of optical disc present in the device. The device according to the invention is defined in claim 1. Due to the applied new measure, the optical pickup unit can hinge a bit around an axis parallel to the radial direction, whereby its tilting angle changes, which adaptation can take place during operation of the optical disc recording and/or reproducing device. In fact this is a simple mechanical solution to solve an optical problem.

It has turned that out, in case different kinds of optical discs are used, small adaptations of the angle between the surface of the disc and the objective lens, in the tangential plane (i.e. rotation around a radial directed axis) can improve the functioning of the device, in particular when information is recorded on the rotating optical disc. Such adaptations are small, for example less than 3.10⁻³ radians, and the optimal angle for each optical disc system can easily be determined by experimentation. The optimal and most reliable functioning of the device for each kind of optical disc is achieved with a different angle of the objective lens relative to the surface of the optical disc for each kind of optical disc.

In a preferred embodiment, said means can hold the optical pickup unit in each of two predetermined positions, and preferably, said means can hold the optical pickup unit also in any position between two predetermined positions. Said tilting angle can be fixed during some time, but the device can also comprise control means for holding the optical pickup unit continuously in optimal position, by controlling the tilting angle by means of a servo mechanism.

In a preferred embodiment, the optical disc recording and/or reproducing device is provided with an optical pickup unit that is guided by means of two guiding rods, both positioned parallel to said radial direction, whereby one of the two guiding rods can be displaced relative to a frame between a location further away from the surface of the rotating optical disc and a location closer to the surface of the rotating optical disc, while the moving guiding rod remains parallel to the surface of the optical disc. Because the distance between the two guiding rods is relative large, the tilting angle can be accurately tuned by a relative large displacement of the said one guiding rod.

Preferably, said one of the two guiding rods can be held at each of two or three predetermined locations, and, more preferably, said one of the two guiding rods can be held in any location between two locations, so that the position of the guiding rod can be controlled by means of a servo mechanism in order to adapt the said tilting angle continuously to its best value.

The other guiding rod, which is not displaceable, guides the optical pickup unit in a straight path in the radial direction, whereby only two degrees of movement remains open: a linear translational motion in said radial direction and a rotational motion around an axis parallel to said radial direction. Thereby said rotational motion is limited by said one guiding rod, whereby it is sufficient that the optical pickup unit engages said one guiding rod at only two spots on the cylindrical surface of the guiding rod. The engagement member can be designed as to allow a variation in the distance between the two guiding rods, so that the following embodiments are possible.

In a preferred embodiment, said one of the two guiding rods has mutually coaxial eccentric portions, whereby each eccentric portion is supported in the frame by means of a bearing. Thereby the displacement of the guiding rod can be achieved by turning the guiding rod around the axis of the two eccentric bearings. Preferably, the bearings are located at or near the ends of the guiding rod.

In another preferred embodiment, said one of the two guiding rods is attached to a hinging part of the frame, whereby said means for changing the tilting angle of the optical pickup unit can hold said hinging part in two or more positions relative to the frame.

Preferably, said one of the guiding rods can be moved by means of a worm gearing, whereby a worm is attached to said frame and an engaging worm wheel is attached to an eccentric portion of the rod (i.e. coaxial compared to the bearings of the rod) or to the hinging part respectively, and whereby the worm is rotational driven by an electric motor. Thereby, the position of the guiding rod can be infinitely, and if desired continuously, varied.

The invention is furthermore related to a method for recording and/or reproducing data by means of a rotation optical disc, whereby an optical pickup unit is guided by guiding means in order to be displaced in substantial radial direction and parallel to the surface of the rotating optical disc, whereby means change the tilting angle of the optical pickup unit in a plane perpendicular to the said radial direction depending on the kind of optical disc present in the device.

The invention will now be further elucidated by means of a description of two embodiments of an optical disc recording and reproducing device comprising an optical pickup unit and guiding means for displacing the optical pickup unit in substantial radial direction. Thereby is made reference to the drawing comprising figures which are only schematic representations of a part of the optical disc recording/reproducing device, in which:

FIG. 1 shows a first embodiment of the device;

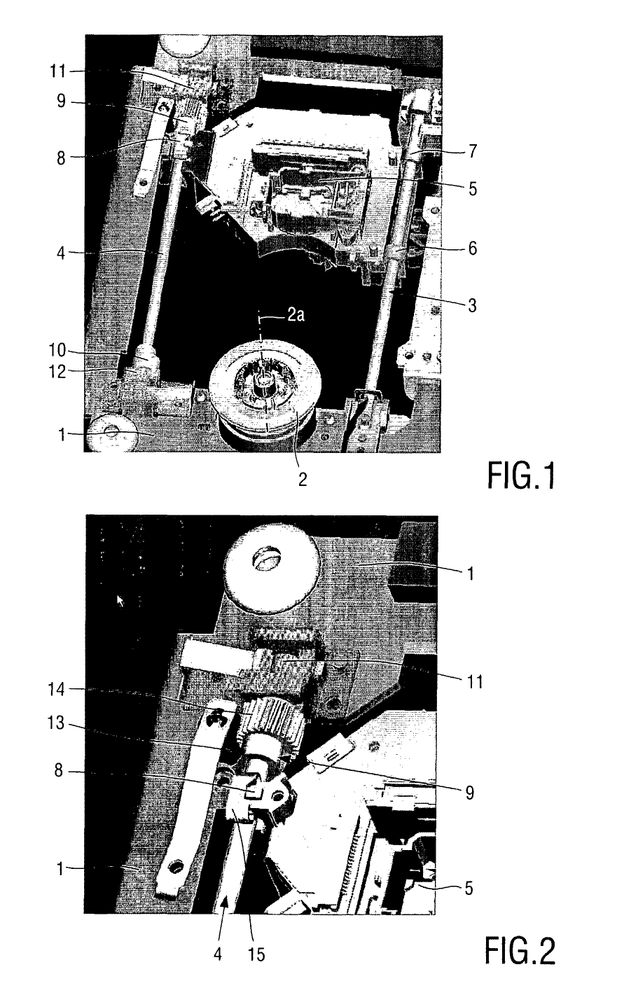

FIG. 2 shows a detail of the first embodiment;

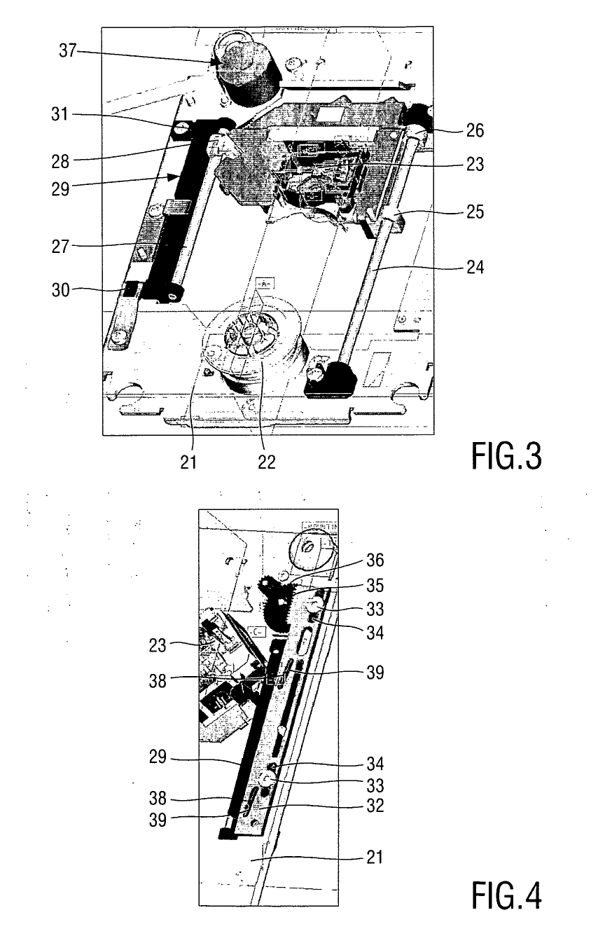

FIG. 3 shows a second embodiment of the device; and

FIG. 4 shows a detail of the lower side of the second embodiment.

FIG. 1 shows a frame 1 that is provided with a rotary table, also called turntable, 2 to which an optical disc (not shown) can be attached. The turntable 2 is rotatable around a rotation axis 2a. Furthermore the frame comprises a first guiding rod 3 and a second guiding rod 4, both having a cylindrical outer surface. Guiding rod 3 is fixed at both ends in frame 1. The optical pickup unit 5 engages the guiding rod 3 by means of two bearings 6,7 at a distance of each other, so that the optical pickup unit 5 can slide along guiding rod 3, i.e. in the direction of the axis of guiding rod 3. Thereby, the central part of optical pickup unit 5 moves in radial direction with respect to rotary table 2. An objective lens (not shown) emitting a converging laser beam is present at said central part, whereby the laser beam can hit the optical disc (not shown) that is attached to the rotary table 2. By moving the optical pickup unit 5 in radial direction, the laser beam can reach a desired region of the surface of the optical disc, whereby the laser beam is directed substantially perpendicular to said surface.

Second guiding rod 4 is engaged by the optical pickup unit 5 by means of one bearing 8, so that the optical pickup unit 5 can only make one motion: a sliding motion whereby the objective lens of the optical pickup unit 5 is moved in a straight path in radial direction parallel to the surface of the rotating optical disc. The means for driving the optical pickup unit 5 along its radial directed straight path are not shown in the figures. Such means can be a worm gear system or any other drive mechanism that can provide for a linear motion.

In order to change the tilting angle of the optical pickup unit 5 in a plane perpendicular to the radial direction, the optical pickup unit 5 can rotate around the first guiding rod 3. Such rotation is achieved by displacing the second guiding rod 4 in a direction perpendicular to its axis. Therefore, both end portions 9,10 of second guiding rod 4 are positioned eccentrically with respect to the central part of second guiding rod 4. The eccentric end portions 9,10 are supported in the frame 1 by means of two coaxial bearings 11,12, so that the axis of second guiding rod 4 is positioned at a distance from the axis of the two bearings 11,12. Rotation of said eccentric end portions 9,10 results in a displacement of the second guiding rod 4 in a direction perpendicular to its axis, whereby said tilting angle of the optical pickup unit 5 changes.

When the second guiding rod 4 rotates, the displacement of that second guiding rod 4 is not a motion in a straight path, but is a motion in a circular path around the axis of the bearings 11,12. Therefore the bearing 8 must allow a relative motion of the axis of second guiding rod 4 relative to the optical pickup unit 5.

FIG. 2 shows the means for displacing the second guiding rod 4 in more detail. Frame 1 is provided with a worm 13, which worm 13 engages worm wheel 14 on the eccentric part 9 of second guiding rod 4. Worm 13 is driven by a electric motor (not shown), whereby a relative fast rotation of worm 13 results in a much slower rotation of worm wheel 14, and therewith a displacement of second guiding rod 4. The bearing 8, which is attached to the optical pickup unit 5, engages the second guiding rod 4 with a fixed flat engaging surface at the back side (in FIGS. 1 and 2) of the cylindrical surface of second guiding rod 4, and with a spring member 15 at the front side of said cylindrical surface, which spring member 15 pushes the second guiding rod 4 against said flat engaging surface. Therefore, the second guiding rod 4 can move in a direction parallel to said flat engaging surface relative to the optical pickup unit 5.

FIGS. 3 and 4 represent a portion of the second embodiment of the optical disc recording and reproducing device. FIG. 3 shows a frame 21 provided with a rotary table 22 for holding an optical disc (not shown). An optical pickup unit 23 can move in radial direction with respect to the rotary table 22, so that an objective lens (not shown) in the central part of the optical pickup unit 23 moves along the surface of the rotating optical disc in a radial directed path.

The frame 21 is furthermore provided with a first guiding rod 24. The ends of the first guiding rod 24 are fixed to the frame 21, and the axis of it is directed parallel to the said radial direction. The optical pickup unit 23 engages the first guiding rod 24 by means of two coaxial bearings 25,26, both attached to the optical pickup unit 23. Therefore, relative to the frame 21, the optical pickup unit 23 can only make a linear translational motion parallel to the said radial direction, and a rotational motion around the axis of the first guiding rod 24.

The optical pickup unit 23 furthermore engages a second guiding rod 27 by means of bearing 28. Both ends of second guiding rod 27 are fixed to a hinging part 29 of frame 21. Hinging part 29 is connected to the remainder of frame 21 by means of two hinges 30,31, so that it can pivot around an hinging axis parallel to the said radial direction. The motion of hinging part 29 relative to the remainder of frame 21 provides for a displacement of the second guiding rod 27 in a direction perpendicular to the axis of second guiding rod 27. This displacement of second guiding rod 27 results in a rotational motion of the optical pickup unit 23 around the first guiding rod 24, and thereby in a change of the tilting angle of that optical pickup unit 23 with respect to the surface of the rotating optical disc.

The means for driving the motion of hinging part 29 are represented in FIG. 4, which FIG. 4 shows the lower side of the frame 21. Said lower side of frame 21 comprises a driving element 32 that can be moved in a straight path parallel to the lower side of the frame 21, whereby it is guided by two guiding pins 33 attached to the frame 21, which pins 33 extend through slots 34 of the driving element 32. Driving element 32 carries a rack 35, which rack 35 is engaged by a gear wheel 36, which gear wheel 36 is driven by electric motor 37 (FIG. 3) at the upper side of the frame 21 through several further gear wheels to provide for a reduction of the rotational speed.

The linear shifting motion of driving element 32 results in a rotation of the hinging part 29, because two protrusions 38 of the hinging part 29 reach in two inclined slots 39 of the driving element 32. So, by moving the driving element 32 by means of the electric motor 37, the hinging part 29 will rotate around the hinging axis of hinges 30,31. The rotation of hinging part 29 causes the displacement of the second guiding rod 27, resulting in the rotation of optical pickup unit 23 around the first guiding rod 24.

The two embodiments of the optical disc recording and reproducing device as described above are only examples; other embodiments are possible.

1. An optical disc recording and/or reproducing device comprising an optical pickup unit, a rotation means for rotating an optical disc around a rotation axis, and a guiding means for displacing the optical pickup unit in substantial radial direction with respect to the rotation axis, wherein means are present for changing the tilting angle of the optical pickup unit in a plane perpendicular to said radial direction depending on the kind of optical disc present in the device.

2. A device as claimed in claim 1, wherein said means can hold the optical pickup unit in each of two predetermined positions.

3. A device as claimed in claim 1, wherein said means can hold the optical pickup unit in any position between two predetermined positions.

4. A device as claimed in claim 1, whereby the optical pickup unit is guided by means of two guiding rods both positioned parallel to said radial direction, wherein one of the two guiding rods can be displaced relative to a frame between a location further away from the surface of the rotating optical disc and a location closer to the surface of the rotating optical disc.

5. A device as claimed in claim 4, wherein said one of the two guiding rods can be held at each of two predetermined locations, and can preferably also be held in any location between said two locations.

6. A device as claimed in claim 4, wherein said one of the two guiding rods has eccentric portions, whereby each eccentric portion is supported in the frame by means of a bearing.

7. A device as claimed in claim 4, wherein said one of the two guiding rods is attached to a hinging part of the frame, whereby said means can hold said hinging part in two or more positions relative to the frame.

8. A device as claimed in claim 6, wherein said one of the guiding rods can be moved by means of a worm gearing, whereby a worm is attached to said frame and an engaging worm wheel is attached to an eccentric portion of the rod or to the hinging part respectively, and whereby the worm is rotational driven by an electric motor.

9. A method for recording and/or reproducing data by means of a rotation optical disc, whereby an optical pickup unit is guided by guiding means in order to be displaced in substantial radial direction and parallel to the surface of the rotating optical disc, wherein means change the tilting angle of the optical pickup unit in a plane perpendicular to the said radial direction depending on the kind of optical disc present in the device.
